(19) United States
(12) Patent Application Publication
(10) Pub. No.: US 2006/0287918 A1
(43) Pub. Date: Dec. 21, 2006

(54) Rolling stock advertising method

(76) Inventor: Jon Canaday, Palm Beach Gardens, FL (US)

Correspondence Address: LOWE HAUPTMAN BERNER, LLP, 1700 DIAGONAL ROAD, SUITE 300, ALEXANDRIA, VA, 22314, US

(21) Appl. No.: 11/433,777

(22) Filed: May 15, 2006

Related U.S. Application Data
(60) Provisional application No. 60/680,522, filed on May 13, 2005.

(51) Int. Cl. G07G 1/14

(52) U.S. Cl. 705/14

(57) ABSTRACT

A method of billing for advertising is described. The method comprises receiving position information indicating a vehicle location wherein the vehicle displays advertising material. The method also comprises receiving traffic information corresponding to at least the vehicle location and generating a billing amount for the advertising material on the vehicle based on correlating the received position information with the received traffic information.

### RELATED APPLICATIONS

The present application claims priority to U.S. Provisional Patent Application Ser. No. 60/680,522 filed on May 13, 2005 and titled, “Rolling Stock Advertising Method” which is hereby incorporated by reference herein in its entirety.

### BACKGROUND

The demand for outdoor advertising is increasing due to traditional advertising media being rendered less effective. Cable television and the advent of television recording devices which provide features for skipping over advertising represent one example of the lessening effectiveness of television advertising. Billboard advertising has been a traditional form of outdoor advertising which in recent years has experienced a drop in effectiveness because of local governmental legislation banning large billboards on a jurisdiction by jurisdiction basis. It is not uncommon to have no billboard advertising on many long stretches of open roads and conversely a large amount of billboards in a dense pattern due to limited jurisdiction allowability. This results in less effective exposures for the advertisers all competing for the same viewer exposure as viewers may not read all the advertisements if presented in a dense format.

As with most all advertising, it is almost impossible to determine the actual number of individuals who may be reading a printed advertisement or listening to a radio advertisement or watching a particular television advertisement. The advertising industry standard is not to charge by actual individuals, as such a determination is difficult to ascertain, but rather by known actual potential exposures based on either circulation rates of printed publications or subscribers to cable television or viewers of broadcast television which may be tracked by independent Nielsen type ratings which attempt to maintain a pulse on the activities of viewers. Ultimately, advertisers want to be certain that their messages are being received by their intended audience and that the advertiser is paying a reasonable price which is based on at least a quantifiable exposure of the advertising.

Advertising a 30-second broadcast television commercial during the once a year football “SuperBowl” may cost an advertiser a million or more dollars due to the estimated large exposure or audience. Conversely, advertising with small audiences are not nearly as expensive but are cost-calculated based on industry averages which may typically vary from industry to industry but for the most part are based on exposures or cost per one thousand (CPM) estimated exposures.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is an example of vehicle advertising routing;

FIG. 2 is an example detail of a destination location;

FIG. 3 is a high level block diagram of a billing system according to an embodiment;

FIG. 4 depicts a high level process flow diagram of operation of an embodiment;

FIG. 5 is a high level block diagram of a billing system according to another embodiment; and

FIG. 6 is a high level process flow diagram of operation of another embodiment.

### DETAILED DESCRIPTION

To the best of the inventor's knowledge, no one in the industry of advertising, specifically truckside (or vehicle-related) billboard advertising, is offering truck advertising billed on a real-time determined “cost per thousand potential view” (CPMPV) basis. CPMPV billing has great value when marketing to companies that desire advertising over a wide geographic area but are fearful the truck and trailer will not be in a location with potential viewers when the viewers are actually present. Experience of the inventor has shown that in at least some instances large trucks and trailers are mobile during the evening and night hours and, conversely, are stationary and spend a great deal of time during the viewable daylight hours loading or unloading at a warehouse dock or a loading station. There may be significantly decreased exposures at night compared to day and, of course, whatever exposures are available at night are rendered moot if the advertisement is unlit in darkness. In many cases, the advertising-bearing trailer (also referred to as rolling stock) may be left at the warehouse dock as additional warehouse space during the unloading and/or loading process. This stationary use of rolling stock is called “drop and hook” in the trucking industry.

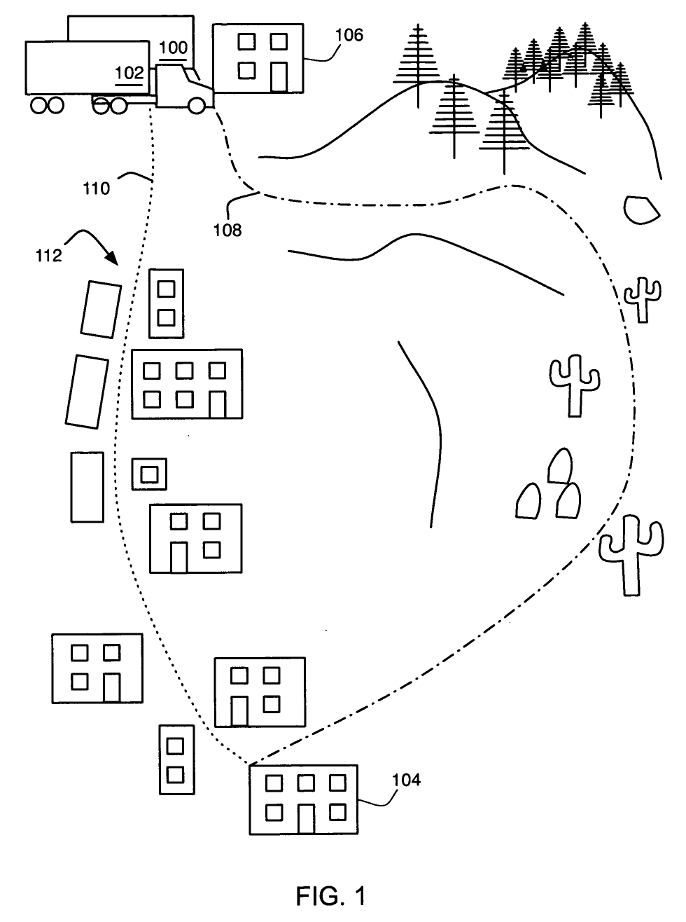

In at least one embodiment depicted in FIG. 1, two trucks, i.e., Truck A 100 and Truck B 102, comprise advertising material affixed thereon, e.g., signage, images, etc. applied to the side of the trailer. Truck A 100 delivers vegetables to a warehouse 104 located one block off main street in Anytown, USA near an interstate highway. While traveling from a distribution loading point 106 to delivery point warehouse 104 in Anytown, Truck A 100 travels along route 108 (dash-dot line) through a remotely traveled region of desert. The CPM exposure rating during this period of travel is greatly lower than Truck B 102 which chooses a different route, i.e., route 110 (dotted line) taking Truck B through a downtown region 112 and heavily traveled and possibly congested roads of a major city. The CPM for Truck B 102 will naturally be higher as the advertising on Truck B has reached more potential viewers or a greater CPMPV and the advertising buyer will be billed accordingly a higher rate for the more effective advertising exposure. Similarly, if Truck A 100 has a flat and is not moving at all, this too will be represented by the accurate location and real-time traffic in and about the rolling stock location.

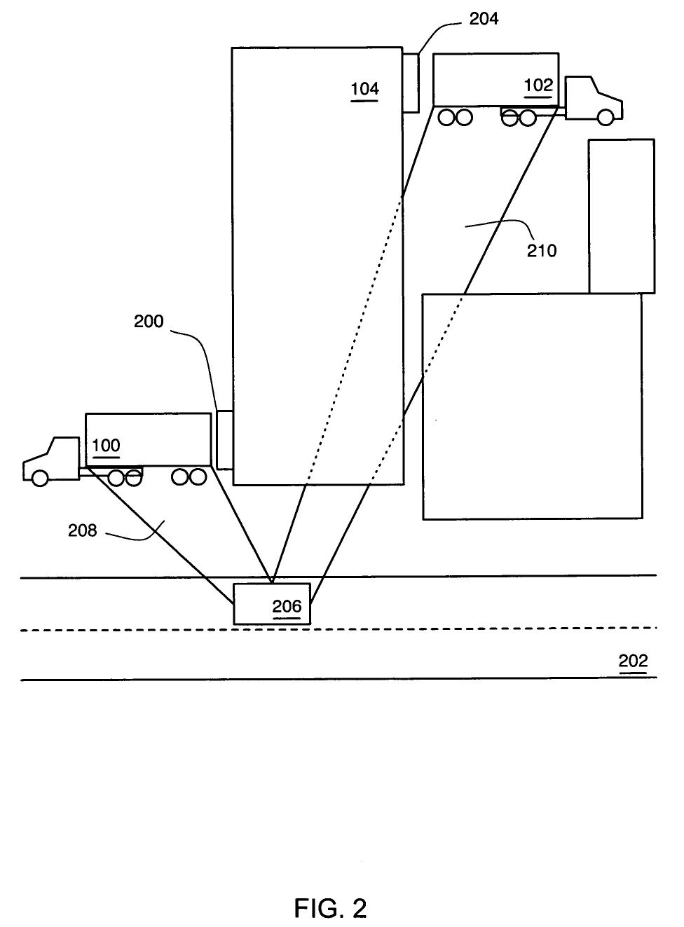

FIG. 2 depicts a high level diagram of truck A 100 and truck B 102 at destination warehouse 104. Truck A 100 and Truck B 102 both arrive with their load of vegetables for the same warehouse 104. Truck A 100 is directed to drop hook the trailer at a particular dock 200. Dock 200 by happenstance abuts the west bound lanes of an interstate highway 202 and the advertising on the trailer 100 is viewable during daylight hours by travelers on the interstate for the entire period of time that the trailer is standing stationary. Conversely, Truck B 102 is directed to drop hook the trailer at dock 204 which by happenstance backs up to warehouse 104 dead-end with no adjacent roads or visible traffic. Both trailers 100, 102 remain stationary for a full day or two while the load of produce is offloaded. Several days may elapse before the stationary trailers 100, 102 are picked up for another service route. During this period, the advertiser advertising on Truck A 100 is being billed for traffic exposure based on an accurate CPM as the traffic on interstate 202 is tracked passing the point within a predetermined map location or radius. Conversely, Truck B 102 has no ascertainable traffic or CPM and the advertiser will receive a greatly reduced invoice in accordance with the accurate real-time tracking and billing method. As depicted in FIG. 2, a vehicle 206 traveling along interstate highway 202 has an unobstructed view 208 of truck A 100; whereas, the same vehicle has an obstructed view 210 of truck B 102.

An advertising rolling stock parked on a heavily traveled main street, e.g., truck A 100 at dock 200, will continue to be billed for passing traffic exposure but an identical trucked parked only one block away and parallel to the main street, e.g., truck B 102 at dock 204, may be receiving no traffic exposure and no bill accrues where there is no advertising exposure. Hence, despite similar geographic location, the advantage of some embodiments of the instant invention is the real-time tracking of actual potential viewer exposures which are not merely estimated or best guess based on historical traffic information.

State of the art mapping software may be used to correlate exact locations of advertising and rolling stock by the use of GPS tracking devices, e.g., GPS tracking devices installed in truck A 100 or truck B 102. Commercially available or government-provided databases may be used to obtain real-time traffic counts for accurate exposure to a specific longitude or latitude at a specific point in time. In some embodiments, an area or a region surrounding or adjacent to a longitude or latitude may be used.

In at least one embodiment, the real-time location of rolling stock and/or the real-time exposure related to a determined longitude or latitude is tracked every ten seconds. In some embodiments, shorter intervals may not be deemed cost effective using current software tracking methods, but shorter times may be customized on an as needed basis in other embodiments. Longer periods of times for a tracking location are also within the ambit of some embodiments of the instant invention. However, according to some embodiments, longer lapse times of about one or more hours may not adequately record traffic patterns which are susceptible to rapid changes due to accident or special events. For example, an accident or rush hour traffic may significantly reduce or increase the CPM exposure. Similarly, a special event such as a long line of traffic for a sporting event may increase the CPM on one stretch of road dramatically, but only on a one-time basis. Some of the embodiments are designed to accurately reflect, in real-time, the CPM and this may be accomplished with ten-second bursts of data although other time intervals are feasible. In another embodiment, the time interval bursts may be stored and sent or transmitted in other time intervals or packets to save transmission costs.

By correlating real-time traffic counting with real-time rolling stock advertising location, a credible and verifiable CPMPV exposure may be established and an invoice generated on which the advertisers can rely.

In at least one embodiment, advertisers who traditionally purchase marketing campaigns in three or six month intervals and wait months or longer periods of time in order to determine the effectiveness of the advertisings may now receive a status of actual view exposures on a real-time basis. Advertisers may use some of the embodiments for specific demographic or geographically targeted advertising, as well as, potential seasonal advertisings. For example, advertisers offering skiing related goods or services may desire targeted advertising in the fall and winter in Northern locations.

Some embodiments of the tracking system provide an embodiment whereby an advertiser may select only rolling stock which is to be viewed with advertising in certain geographic regions. The CPM rate may be limited or lowered or deleted in certain zip codes or regions where the advertising is not desired or deemed most effective and conversely, the full rate for CPM may be billed when the advertising is in the desired target zip code or geographic region. Such targeted advertising is very desirable to certain marketers who may target by varying demographics and/or geography and be billed by actual real-time traffic or CPMPV in those desired targets.

For example, a truck delivering goods in a Spanish speaking section of a city on a regular basis may only be accumulating accurate CPM's based on the exposures in the zip codes where the advertiser determined viewers read Spanish. Conversely, no charges may be billed in other demographic delivery zones not meeting the advertiser's target audience.

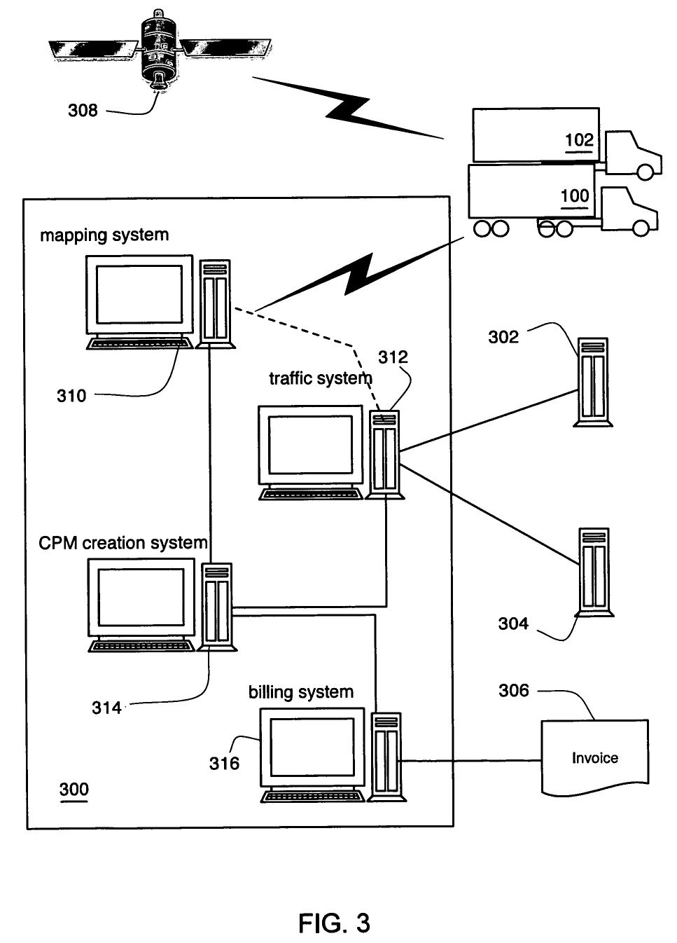

FIG. 3 depicts a high level block diagram of an embodiment of a CPMPV-based system 300. CPMPV-based system 300 communicates with one or more vehicles, e.g., truck A 100 and truck B 102, one or more commercial traffic data providers 302, and one or more government traffic data providers 304, and generates a CPMPV-based invoice 306 for an advertiser. As depicted, vehicles 100, 102 receive signals from a GPS satellite 308 in order to determine the vehicle location. GPS satellite 308 signals also provide time information.

In one or more embodiments, GPS satellite 308 may be replaced or enhanced through the use of one or more replacement/additional location determining systems, e.g., other satellite-based systems such as GLONASS and Galileo, ground-based systems such as LORAN, etc.

CPMPV-based system 300 comprises a mapping system 310 for receiving position information from vehicles being tracked, e.g., truck A 100 and truck B 102. Mapping system 310 maintains one or more databases retaining position information on vehicles 100, 102. Position information received from a vehicle includes time information. In at least some embodiments, the received position information includes a timestamp indicating the time at which the position information was determined. In some embodiments, the timestamp information comprises date and/or time information. In some further embodiments, the position information includes a timestamp indicative of the time at which the position of the vehicle was determined. In some further embodiments, the timestamp information represents the time in the received GPS signal used to determine the vehicle position.

CPMPV-based system 300 further comprises a traffic system 312, a CPM-determination system 314, and a CPMPV billing system 316. Traffic system 312 obtains traffic information, e.g., real-time, non-real-time, etc., from one or more commercial traffic data providers 302 and/or one or more government traffic data providers 304. In at least some embodiments, traffic system 312 obtains traffic information from traffic data providers 302, 304 based on position information obtained from mapping system 310 (indicated by dashed line). That is, in some embodiments, traffic system 312 requests traffic information from one or both of traffic data providers 302, 304 where the traffic information requested corresponds to one or more routes and/or locations of vehicles 100, 102.

CPM-determination system 314 correlates the position information maintained by mapping system 310 with the traffic data information maintained by traffic system 312 in order to determine the CPM of vehicle 100 position. Determination system 314 may provide the CPM determinations per vehicle to CPMPV billing system 316.

CPMPV billing system 316 generates an invoice for an advertiser for a vehicle based on an advertising rate and the determined CPM for the vehicle from the CPM-determination system 314.

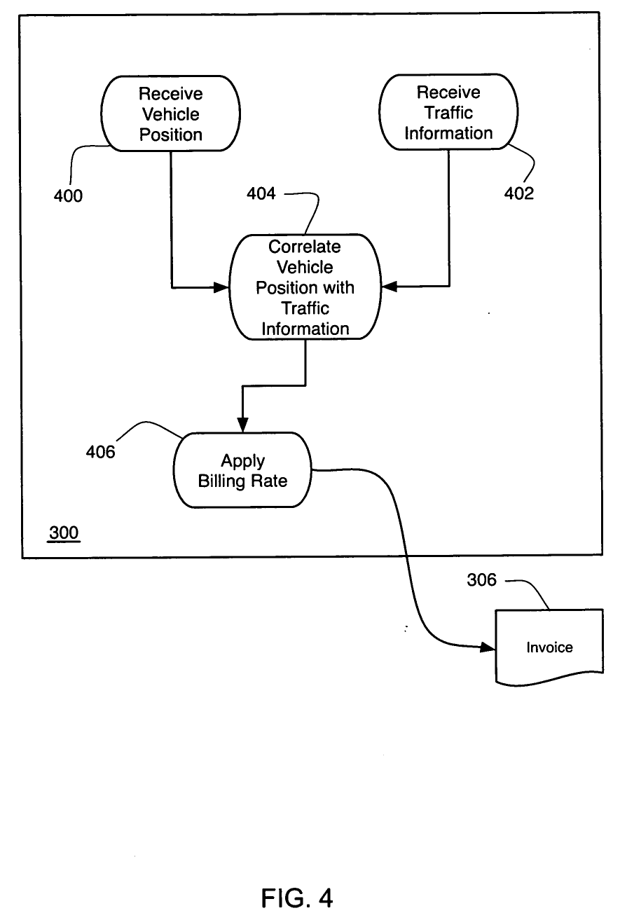

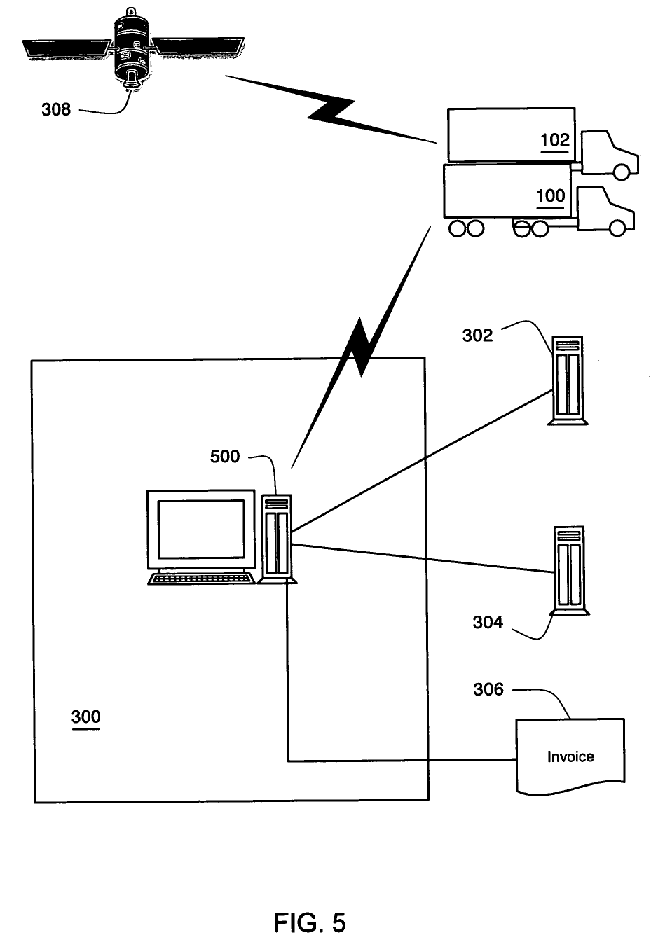

In some embodiments, one or more of the components of CPMPV-based system 300 may be combined. FIG. 5 depicts an embodiment in which each of system 300 components, i.e., mapping system 310, traffic system 312, CPM-determination system 314, and CPMPV billing system 316, are combined into a single system 500. The functionality of system 500 operates according to the process flow diagram of FIG. 4.

FIG. 4 depicts a high level process flow diagram of operation of an embodiment of CPMPV-based system 300. As depicted, execution of a receive vehicle position function 400 by CPMPV-based system 300 causes the system to receive vehicle 100 position information. In some embodiments, vehicle 100 provides periodic position information updates, e.g., every ten seconds. Further, execution of a receive traffic information function 402 by CPMPV-based system 300 causes the system to receive traffic information from one or both of commercial traffic data provider 302 and government traffic data provider 304. In some embodiments, the received traffic information includes timestamp information indicating a time period during which the received traffic information is valid or to which the information pertains. In at least some embodiments, traffic information is received by system 300 on a periodic basis, e.g., every 10 seconds, in order to ensure accurate traffic information with respect to the position information. In other embodiments, system 300 may request updated traffic information responsive to receipt of position information.

CPMPV-based system 300 further includes a correlation function 404 which, when executed by the system, causes the system to correlate the received vehicle position information from vehicle position function 400 with the received traffic information from traffic information function 402. In some embodiments, correlation function 404 is executed by system 300 on a periodic basis. In some other embodiments, correlation function 404 is executed by system 300 based on a change of either or both of position information and traffic information.

In at least some embodiments, the correlation of the position information with the traffic information is performed based on a comparison of the timestamp information of the position information with the timestamp information of the traffic information. For example, position timestamp information for truck A 100 at a particular time is used to determine which traffic information is to be correlated with the position information. In at least one embodiment, the position timestamp information, i.e., the timestamp of a particular received position information, is compared to one or more traffic timestamp information of received traffic information.

Because timestamp information may differ between the systems, a match may be determined if the traffic timestamp information is found to be within a predetermined time period of the position timestamp information.

Further, in at least some embodiments, system 300 performs a filtering of traffic information to include traffic information within a predetermined distance from the received position information. In some embodiments, the received traffic information is requested by system 300 by a request specifying a particular route(s) of interest with respect to which traffic information is requested. In some embodiments, the traffic information for more than one route within a predetermined vicinity of the position information is combined to calculate the number of potential viewers of the advertising material on the vehicle.

In at least some embodiments, the request for traffic information may specify a particular location, region, point of interest, address, or other area or location-specifying mechanism. In other embodiments, the received traffic information is received in response to a request from system 300 without specifying a particular route and the system performs any filtering of the traffic information with respect to the position information.

In some embodiments, geographical information may be used to determine the viewable nature of the position information, e.g., known geographic features such as mountains, etc. may block visibility of a particular position. Additionally, known building locations may block visibility of a particular position as depicted in FIG. 2.

CPMPV-based system 300 also includes a billing function 406 which causes system 300 to determine a charge for an advertiser based on applying a predetermined billing rate to the correlated position information and traffic information based CPM from correlation function 404. Execution of billing function 406 by system 300 causes the generation of invoice 306. Billing function 406, in some embodiments, may be executed on a periodic basis, e.g., daily, weekly, monthly, etc.

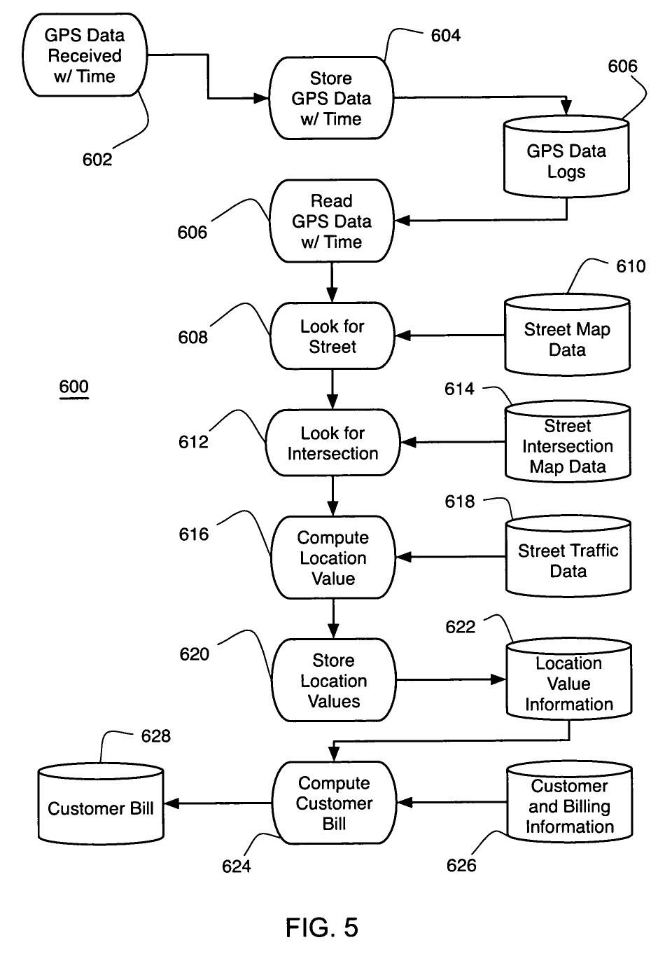

FIG. 6 depicts a high level process flow 600 diagram of operation of another embodiment. The process flow begins at function 602 wherein GPS data is received periodically from an installed sensor in a vehicle, e.g., truck A 100. The process flow proceeds to function 604 wherein the received GPS data is stored to a data store, e.g., a file, disk, or other mechanism for later retrieval of the information. A GPS data logs data store 606 stores the GPS data and maintains a list of all locations and times across a defined time period.

At function 606, GPS data records are retrieved from the stored GPS data logs via wired or wireless connection. The flow proceeds to function 608 wherein system 300 searches street map data for the closest street to a GPS location in a GPS data record. In an embodiment, function 608 searches for streets within a predetermined distance from the GPS data record location information. Function 608 uses street map data from street map data store 610 which stores map data. For example, in one embodiment street map data store 610 stores vectorized maps of applicable streets. The flow proceeds to function 612.

At function 612, system 300 searches a street intersection map data store 614 for one or more intersections within a predetermined distance of the GPS record location information. In at least one embodiment, intersection data contains combined traffic data. Street intersection map data store 614 stores locations of street intersections. The flow proceeds to function 616.

At function 616, system 300 computes a value for a GPS data record based on street traffic and values from a street traffic data store 618. In at least one embodiment, function 616 operates on generic or specific street traffic information. Street traffic data store 618 stores generic and specific traffic and pricing information corresponding to streets. The flow proceeds to function 620.

At function 620, system 300 stores the function 616 generated values in a location value information data store 622 for later use in billing. In at least one embodiment, functions 606, 608, 612, and 616 are repeated for each GPS data record for a vehicle which is stored in GPS data logs data store 606. Location value information data store 622 stores financial values associated with each GPS data record. The flow proceeds to function 624.

At function 624, system 300 uses location value information from location value information data store 622 and customer data stored in a customer information data store 626 to generate a bill for street values for one or more vehicles assigned to advertise for the customer. The generated bill from function 624 is stored in customer bill data store 628.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method of billing for advertising, comprising:
receiving position information indicating a vehicle location wherein the vehicle displays advertising material;
receiving traffic information corresponding to at least the vehicle location; and
generating a billing amount for the advertising material on the vehicle based on correlating the received position information with the received traffic information.

2. A method according to claim 1, wherein the receiving position information comprises position timestamp information; and
wherein the receiving traffic information comprises traffic timestamp information; and
wherein the generating comprises correlating the position information with the traffic information based on traffic information with traffic timestamp information within a predetermined time period of the position timestamp information.

3. A method according to claim 1, wherein the receiving position information comprises position timestamp information and
wherein the receiving traffic information comprises receiving traffic information within a predetermined time period of the position information.

4. A method according to claim 1, wherein the generating comprises determining one or more routes within a predetermined distance from the received position information.

5. A method according to claim 4, wherein the generating comprises combining traffic information from the determined one or more routes within a predetermined distance from the received position information.

6. A method according to claim 1, wherein the receiving position information occurs on a periodic basis.

7. A method according to claim 6, wherein the period is 10 seconds.

8. A method according to claim 1, wherein the receiving traffic information occurs on a periodic basis.

9. A method according to claim 1, wherein the receiving traffic information occurs responsive to the receiving traffic information.

10. A method according to claim 1, wherein the generating occurs on a periodic basis.

11. A method according to claim 1, wherein the generated billing amount is based on the number of potential viewings related to traffic information within a predetermined time period of the position information.

12. A method according to claim 11, wherein the generated billing amount is more during time periods when the vehicle is viewable at a position by a volume of traffic as compared to time periods when the vehicle is not viewable at a position by the volume of traffic.

13. A method according to claim 1, wherein the generated billing amount is based on increments of cost per one thousand exposures determined based on the traffic information and the position information.

14. A method according to claim 1, wherein the traffic information is real-time traffic information.

15. A memory or a computer-readable medium storing instructions which, when executed by a processor, cause the processor to perform the method of claim 1.

16. An advertising billing rate system, comprising:
a mapping system for receiving position information from a vehicle comprising advertising material;
a traffic system for receiving traffic information related to the position information;
a cost determination system connected with the mapping system and the traffic system and configured to correlate traffic information received from the traffic system with the position information received from the mapping system and generate a cost per unit of potential viewers based on traffic information related to the position information.

17. An advertising billing rate system according to claim 16, further comprising:
a billing system for generating an invoice based on the generated cost per unit from the determination system.

18. An advertising billing rate system according to claim 16, wherein the mapping system is configured to periodically receive position information.

19. An advertising billing rate system according to claim 16, wherein the traffic system is configured to periodically receive traffic information.

20. An advertising billing rate system according to claim 16, wherein the traffic information corresponds to real-time traffic information within a predetermined time period of the position information.
